(19) United States
(12) Patent Application Publication
(10) Pub. No.: US 2007/0256003 A1
(43) Pub. Date: Nov. 1, 2007

(54) Platform for the interactive contextual augmentation of the web

(76) Inventors: Seth Wagoner, Christchurch (NZ); Karl Dearden, Christchurch (NZ)

Correspondence Address: LOUIS VENTRE, JR, 2483 OAKTON HILLS DRIVE, OAKTON, VA, 22124-1530, US

(21) Appl. No.: 11/739,691

(22) Filed: Apr. 24, 2007

(30) Foreign Application Priority Data
Mar. 21, 2007 (NZ) NZ554030
Feb. 2, 2007 (NZ) NZ553015
Oct. 18, 2006 (NZ) NZ550645
Apr. 24, 2006 (NZ) NZ546751

(51) Int. Cl. G06F 17/00; G06F 3/048

(52) U.S. Cl. 715/501.1; 715/530; 715/531; 715/808

(57) ABSTRACT

A method for increasing the usefulness of hypertext in a browser accessed web site by providing means to augment hyperlinks and other notable page content with additional metacontent and contextually appropriate tools by inserting a script into browser accessed document that when rendered by a web browser causes the link objects within a Document Object to be augmented with extra information relevant to the linked URL, said information obtained from a different domain than the one on which the document resides.

### CROSS-REFERENCE TO RELATED APPLICATIONS

The present invention claims the benefit of the filing date of New Zealand provisional applications NZ554030 filed 21 Mar. 2007, NZ553015 filed 02 Feb. 2007; NZ550645 filed 18 Oct. 2006; and NZ546751 filed 24 Apr. 2006 the text of which are incorporated by reference herein.

### FIELD OF INVENTION

In the field of Internet utilization relating to the presentation of information suitable for the administration of commodities, financial transactions, or recreation.

### DESCRIPTION OF PRIOR ART

A standard web page has hyperlinks designed to lead the reader to information relevant to the current document. Often the linked documents are outside the control of the author of the web page.

Therefore it is a very common occurrence for linked documents to change or disappear without the author of the referring document realizing, and increasingly common for the URL to now point to automatically generated content specifically designed to monetize the reader's clickthrough. In the worst case, following such a link can involve the background installation of malware without the user's knowledge through a browser security hole.

Even where the linked document is more or less the same as when the author linked to it, it is often the case that the main body content is displayed within ever changing navigation links containing the latest news, advertising, links to common searches, recent comments, and so forth, which may distract the reader if they view that page. Hence by linking to external content, a webmaster risks losing the attention of their reader, and by following the link, the reader risks being distracted from their current train of thought.

Furthermore, since one hyperlink usually looks very much like any other unless the page author or website developer has gone to special effort to highlight unusual links in some fashion, a user often has no idea what they are clicking on until after they have clicked. Existing CSS standards allow for changing the color of the link according to whether the user has visited it in the past, or if the mouse is currently over it, but anything more advanced requires some scripts to execute.

Even very experienced web users are often given momentary irritation when they click on a mailto link or a link to a large PDF file when they were expecting a standard web page, for instance, and users unskilled in the art are often confused by links to internet protocols and file formats that are unfamiliar to them.

Experienced readers (‘surfers’) will often check the URL in the status bar of a web browser before they click on a link. However sometimes this URL is uninformative, for instance when it goes through a redirection mechanism, and sometimes scripts deliberately prevent the URL from appearing in the status bar, or replace it with descriptive text. More often, the surfer will simply not check, because they think they know roughly what they will be clicking on.

Experienced web authors often warn their readers when they link to something that might be unexpected. However their expectations may different to their readers, and in any case they will be unable to anticipate the needs of their entire audience.

Some search engines have been written to insert thumbnail sized images of web pages next to search results, however these thumbnails do not provide readable text. Also, services exist (e.g. Alexa and Thumbshots) to distribute these thumbnails, but distributing text based metacontent is a very different art that is more useful, less bandwidth intensive, but considerably more difficult in its design and execution.

Existing websites within the art contain embedded IFRAMEs that will show the entire page resulting from a search (e.g. Previewseek.com). Other existing websites within the art display a manually selected fragment from the contents of a linked page (e.g. Clipmarks.com). But these are web pages designed to show these IFRAMES, rather than a script designed to add IFRAMEs to any existing web page.

Some javascript code known in the art will allow a webmaster with some care to automatically alter the appearance of existing hyperlinks on their page relevant to the URL of the hyperlink. But this code is to be installed on the webmaster's server , rather than centrally maintained code on another server, or code designed to source information about the links from external sources with minimal effort from the webmaster, which is an object of the present invention.

Known art includes methods for scraping the body content from inside HTML. Prefetching HTML content onto a central server, summarizing it on that server and waiting until a user requires it is one known method.

However known methods do not allow for failover to client based summarization of content not accessible to a central server due to elements such as firewalls and robots.txt rules. Further, massive infrastructure resources are required to prefetch content like this on the public network. There is therefore, a lack of systems in the art which address on-demand presentation of summarized content from disparate sources.

An object of the present invention is to provide a new method and system to combine summarization tools in a realtime environment to display document summaries on demand without requiring a pre-crawl of the internet or intranet.

Some browser extensions known in the art seek to augment hyperlinks by displaying a fully rendered preview of the target link in a separate browser window or linked application, utilizing the preloading of web content to speed up the preview process, but not known in the art is a browser extension which uses xmlHTTPrequest followed by text based pattern matching followed by DOM manipulation to render a summary of the most important text in the document, along with additional metadata, or other appropriate forms of augmentations related to binary files.

Another feature of the present invention is that the scripts may act in concert with browser or browser extension functionality that gives them access to local storage, in which case all scripts, preferences, and ClueScripts may be stored locally.

Another feature of the present invention is that the scripts may act in concert with browser or browser extension functionality that gives them access to pages that do not contain loadlines, and/or browser level events, in which case the functionality may be applied to any page.

Another feature of the present invention is that the scripts may act in concert with a proxy server that inserts the necessary loadline(s) into the HTML pages that pass through it, or insert entire scripts obviating the need for loadines.

Another feature of the present invention is that the scripts may act in concert with the browser or an extension, or a server side proxy to give access to cross site scripting—i.e., taking content direct from another URL e.g. with a privileged xmlHTTPrequest, or using the cross-site scripting capability of Adobe Flash, or a proxy service that inserts script lines that contain data sourced from the external domain. . This allows for a new class of ClueScripts that act direct on the target page to create summaries and metadata at the client side rather than the server side.

An object of the present invention is to provide a new method and device to allow hyperlinks within a hypertext document to be augmented to display information related to the target document of the hyperlink (metacontent) without requiring the reader to leave the context of the current document.

Two forms of augmentation comprising part of the present invention are dynamic LinkClues and ClueFrames.

LinkClues are information bearing icons inserted next to a hyperlink, while a ClueFrame is an interactive frame in which metacontent is displayed along with various controls that the user may find useful in the context of the currently selected link, or the currently viewed page. (Metacontent, in this context, means content that is “about” a link, or “about” the current page).

Another object of the present invention is to allow a webmaster to augment hyperlinks on their website with minimal effort.

Hence a feature of the present invention is that webmasters need only insert a LoadLine into their documents to load externally hosted Scripts which create the metacontent User-Agent within the user's web-browser environment.

Another feature of the present invention is that a plurality of metacontent items may be displayed for a single hyperlink.

Another feature of the present invention is that a plurality of metacontent item types may be displayed within the metacontent display area—as opposed to a simple list of search results from a search engine, for instance.

Another feature of the present invention is that the DOM (Document Object Model) of the document currently viewed by the user may be altered to indicate the availability of one or more metacontent types for specific hyperlinks within the DOM.

Another feature of the present invention is that alterations to the DOM of the displayed document may be made in such a way that the appearance of a link only changes, or icons only appear, when the user has selected a link or paused their cursor on it for a given period of time.

Another feature of the present invention is that a plurality of metacontent items may be incorporated within a single tooltip-style window that appears in response to the user's link selection or mouse pointer behavior. This can take the form of a “pop-up” window with a separate DOM, or a “floating DIV” (i.e. a <DIV> element with a high Z-index such that it floats on top of other content)

Advantageously, the activation method may be tied to the mouse cursor pausing, rather than by way of events attached to links and other content in a page.

A feature of the present invention is that the servers providing the metacontent delivery service may obtain the metacontent relevant to a given target URL from a plurality of derived metacontent URLs on a plurality of servers according to various transformation rules determining the location of source content and rules for the transformation of the source content into metacontent to be displayed to the user.

Another feature of the present invention is that the user-agent client code may also obtain the metacontent relevant to a given target URL from a plurality of derived metacontent URLs on a plurality of servers according to various transformation rules determining the location of source content and rules for the transformation of the source content into metacontent to be displayed to the user. In the trivial case, this is by way of including images, IFRAME content, and embedded objects sourced on different servers. In the more complicated case this is by way of using script loading lines similar to those served up by the primary servers that are more commonly used. Other methods of cross-site content loading are possible, e.g. by way of Flash objects, and more may become possible in the future.

Another feature of the present invention is that untransformed metacontent items may be sourced safely from 3^{rd} party locations by way of injecting IFRAMEs into the metacontent display window, or by embedding images or other objects.

Another feature of the present invention is to allow a webmaster to customize the appearance and behavior of the link augmentations on their site, by way of

a) Storing the preferences within the pages being augmented, using properties or function calls.

b) Storing preferences in specific file(s) that the user agent looks for, e.g. in the root folder of a domain or the current directory

c) Storing preferences on the server and having the user agent identify which preferences to use by the URL of the page or by an ID stored within the page.

Another feature of the present invention is to allow the behavior to be personalized by the reader and for those user preferences to be stored in a cookie, or in another client-side storage mechanism, or stored on a server and identified by settings within the cookie or other client-side storage mechanism.

Another feature of the present invention is that the metacontent delivery server(s) may act on a “per site” basis by creating metacontent for all appropriate content linked from all documents within a domain or directory on a domain.

Another feature of the present invention is that the metacontent delivery server(s) may act on a “just in time” basis by creating metacontent for content linked from documents where the User-Agent has been activated by a web-browse.

Another feature of the present invention is that the metacontent delivery server(s) may act on a new content notification method, where new items on a supported site are discovered on a “ping server” or from a syndication feed.

Another feature of the present invention is that the metacontent item types may include a summary of the target document.

Another feature of the present invention is that the metacontent item types may include metadata created by an analysis of the target document (intrinsic metadata).

A feature of the present invention is that the server may obtain the metacontent relevant to a given target URL from a plurality of derived metacontent URLs on a plurality of servers according to various transformation rules determining the location of source content and the transformation of the source content into the metacontent to be displayed to the user.

Another feature of the present invention is that rules may be defined for attaching metacontent to unlinked items, by way of first using a transformation rule to find an appropriate target URL for the item, and then providing metacontent relevant to that target URL in the same manner used for ordinary hyperlinks. In an alternative embodiment, an identifier other than a URL may be used for a database lookup to find relevant metacontent.

Another feature of the present invention is that rules may be defined for showing metacontent relevant to the source page in the same manner used for links to target pages, and the this may be shown on pageload or triggered by user activity.

Another feature of the present invention is that rules may be defined for showing content relevant to text selected by the reader on the page.

SiteClues

The preferred embodiment described in the following is denoted “SiteClues”. In the described embodiment the rules for each metacontent item type including the type's name, source content location, content transformation rules, preferred display format and activation time and so on are denoted as a “ClueScript” and the collection of these types is the ClueScript Directory. In the preferred embodiment, the set of source content location and content transformation rules are stored in a ClueScript Directory implemented in a database table, but they could also be stored within various file formats known to those skilled in the art. . Also for the purposes of this invention the word “ClueTab” is used to denote the selector for a metacontent item (or “Clue”) which appears within a display area denoted as a “CluePanel”. Indicators placed next to hyperlinks and special content items are denoted as LinkClues.

ClueScripts

A feature of the present invention is a device and process whereby the user-agent may obtain meta-content for display from a plurality of URLs on a plurality of servers according to various rules, the rules for each type of metacontent to be stored within a database, or in definition files or in other objects, and either distributed in bundles or downloaded on demand from a server.

In the preferred embodiment, each item of metacontent is fetched and processed according to rules stored within a “ClueScript”. ClueScripts may be written, stored and distributed in various formats known to those skilled in the art, but a javascript object notation has the advantage that it's transformation into a runtime object is particularly swift, so this form of javascript is used within the preferred embodiment.

The functions and properties defined within a ClueScript include:
(1) Name, Description
(2) Icon(s) for display next to links to indicate availability of metacontent (LinkClues)
(3) Icon(s) for display on mouseover to allow selection of that metacontent item for display (ClueTabs)
(4) Rules for applicability of the ClueScript to specific classes of URLs.
(5) Rules for identifying unlinked content items of interest and associating them with a URL for the purpose of identifying relevant metacontent items.
(6) A method for determining the location of source material for the metacontent.
(7) A method for obtaining source material for the metacontent
(8) Whether to show a ClueTab or LinkClue before the source material has been collected.
(9) The interaction event on which the source material should be obtained (on PageLoad, onLinkSelect, or onClueSelect)
(10) A method for transforming the source material into the metacontent for display to the user.
(11) Whether the ClueScript is trusted—meaning that the metacontent is trusted not to contain malicious scripting content.
(12) The underlying platforms on which the ClueScript may or may not be executed.
(13) Any ClueScript specific configuration properties that may be set by webmaster customization or user personalization and used as macro values in any of the above.

Cluescripts may be created either by the extension developers, or third parties. They may be deployed with a browser extension and updated as part of the same process by which the extension is updated, or they may be downloaded and updated by a separate process, either by the installation of separate files, or by download into the extension from a central server. In an advanced embodiment batches of ClueScripts may be deployed and updated as a unit, and the extension may be initially deployed with or without pre-installed.

ClueScripts

Cluescripts may access variables set by other cluescripts. In an advanced embodiment they may only access variables set by the global

LinkClues

In the preferred embodiment, icons are placed next to links to indicate the type of link, and the type(s) of metacontent items available for that link. These icons are denoted “LinkClues” in this embodiment.

Some LinkClues are determined purely based on static criteria, for instance a URL ending in “.pdf” may be assumed to be an Adobe PDF document, and an icon indicating a PDF document inserted as a LinkClue. This static technique already exists within the art, for instance it is implemented by the “TargetAlert” Firefox extension.

A feature of the present invention is a process which enables the fetching and presenting of a target page's “favicon” (a small image file associated with sites or pages usually shown in the window's title bar) next to the target link within the web page before or after the HTML data has been downloaded for the target page.

Another feature of the present invention is that the “title attribute ”of the <IMG> tag containing a LinkClue icon may be determined dynamically at runtime, and extra data computed at runtime that appears on mouseover of a LinkClue icon or the link itself may be added.

Another feature of the present invention is that the event triggering display of the ClueFrame may be inactive until the appropriate status has been reached, thus eliminating time spent staring at a window with a “loading” icon in it and nothing else.

ClueFrames

In the preferred embodiment, metacontent items are displayed within a tabbed interface (the ClueFrame) with one tab (ClueTab) and an associated panel per metacontent item (Clue). An alternative embodiment would allow for metacontent to be displayed within a single pane, optionally scrollable within an IFRAME, possibly with “collapsible” hide/unhide segments, possibly in a hierarchical outline format.

In the basic mode only summary information is displayed in the ClueFrame, after the content for the summary has been successfully downloaded.

In the advanced mode multiple qualifying ClueScripts are available to the user. In the preferred embodiment they are displayed within a tabbed interface. An alternative embodiment would allow for the activation and display of cluescripts to be triggered by menu items, another alternative embodiment allows for Clue content to be displayed within an interactive outline or multi-part document within the ClueFrame.

In either mode, a row of buttons may appear above and/or below the content pane, most of which are always there, but some of which may be defined within a ClueScript.

Optionally back&forward buttons allow the user to move between a history of viewed Clues within the ClueFrame.

Optionally, a history pane may be displayed which shows a history of both pages visited and Clues seen while on those pages.

Preferences

Preferences regarding the configuration of the platform may be set by the webmaster or the user, overruling defaults set by the central server, and within the cluescripts. The preferences may be stored:
(1) On the central server, and identified either by the sites domain, a cookie, or another form of client-side storage.
(2) Directly within a cookie or another form of client-side storage
(3) Within the DOM of the page itself, temporarily as loaded from elsewhere, or for changes only affecting the current page.
(4) Webmaster preferences defined within the current page, another file on the same domain, or another file accessible via methods in the art that work around cross-site scripting such as loading JSON files.

Some Preferences Affecting the Display of LinkClues and the ClueFrame.
ClueFrame Skin (Selects a set of HTML, images and/or CSS files that determine the appearance of the ClueFrame)
The List of ClueScripts to Display
Which set of LinkClues to use, or whether to only use a single icon image rather than information bearing icons, or whether to show no LinkClue icons at all.
Whether to attach the onSelectLink even to the Link or the LinkClue.
How long the mouse pointer must stop on the link or LinkClue before the onSelectLink event occurs.
Whether to fade the ClueFrame in and out, and how many fade steps.
Whether to fade the LinkClues in and out on mouseover, and how many fade steps.
   Use of a specially adapted Browser or Browser Extension

Another feature of the present invention is that the scripts may act in concert with a browser or browser extension to give them access to local storage, in which case all scripts, preferences, and cluescripts may be stored locally.

Another feature of the present invention is that the scripts may act in concert with browser or browser extension functionality that gives them access to the DOM of pages within the browser that do not contain loadlines, and/or browser level events, in which case the platform functionality may be applied to any page the user sees.

Another feature of the present invention is that the scripts may act in concert with a proxy server that inserts the necessary loadline(s) into the pages that pass through it, or insert entire scripts, obviating the need for loadlines.

Another feature of the present invention is that the scripts may act in concert with the browser or an extension, a client or server side proxy to allow cross site scripting—i.e., taking content direct from another URL e.g. with a privileged xmlHTTPrequest, or using the cross-site scripting capability of Adobe Flash, or a proxy service that inserts script lines that contain data sourced from the external domain. . This allows for a new class of ClueScripts that act direct on the target page to create summaries and metadata at the client side rather than the server side.

Another feature of the present invention is that when scripts act in concert with the browser or an extension, extra metacontent may be sourced at runtime from the target document, the referrer document, the browser environment, applications I running within the user's operating system, a master server known to the extension, or 3^{rd} party server(s), and this content may be transformed into an appropriate format before being shown to the user.

Unlike Browster's “enhanced browing window” which is really a seperate application capable of being bound to outlook, for instance, the clueframe is created completely within the DOM of the current page, which brings various advantages and disadvantages, for instance it has no native functions for dragging or resizing, and the data fetched goes through an arduous process as opposed to just being rendered in the standard fashion.

Further aspects and advantages of the present invention will become apparent from the ensuing description and drawings, which are given by way of example only.

### BRIEF SUMMARY OF THE INVENTION

A method for increasing the usefulness of hypertext in a browser accessed web site by providing means to augment hyperlinks and other notable page content with additional metacontent and contextually appropriate tools by inserting a script into browser accessed document that when rendered by a web browser causes the link objects within a Document Object to be augmented with extra information relevant to the linked URL, said information obtained from a different domain than the one on which the document resides.

### BRIEF DESCRIPTION OF THE DRAWINGS

FIG. 1 is a chart depicting the Browser based System Structure according to one embodiment of the invention.

FIG. 2 is a chart depicting the Browser based System Structure according to one embodiment of the invention.

FIG. 3 is a flowchart depicting the Initialisation Processes according to one embodiment of the invention .

FIG. 4 is a flowchart depicting the DOM Initialisation Process according to one embodiment of the invention.

FIG. 5 is a flowchart depicting the Link Selection Process according to one embodiment of the invention.

FIG. 6 is a flowchart depicting the Link Initialisation Process according to one embodiment of the invention.

FIG. 7 is a flowchart depicting the ClueScript Source Data Retrieval according to one embodiment of the invention.

FIG. 8 is a flowchart depicting the ClueScript Selection and Execution process according to one embodiment of the invention.

FIG. 9 is a flowchart depicting the ClueFrame processes according to one embodiment of the invention.

FIG. 10 is a flowchart depicting a Desktop Server page load process according to one embodiment of the invention.

FIG. 11 is a flowchart depicting the onPageLoad processes for SiteClues according to one embodiment of the invention.

FIG. 12 is a flowchart depicting the onLinkSelect and onClueSelect processes for SiteClues according to one embodiment of the invention.

FIG. 13 is a structure diagram depicting SiteClues according to one embodiment of the invention.

### DETAILED DESCRIPTION

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural and operational changes may be made without departing from the scope of the present invention.

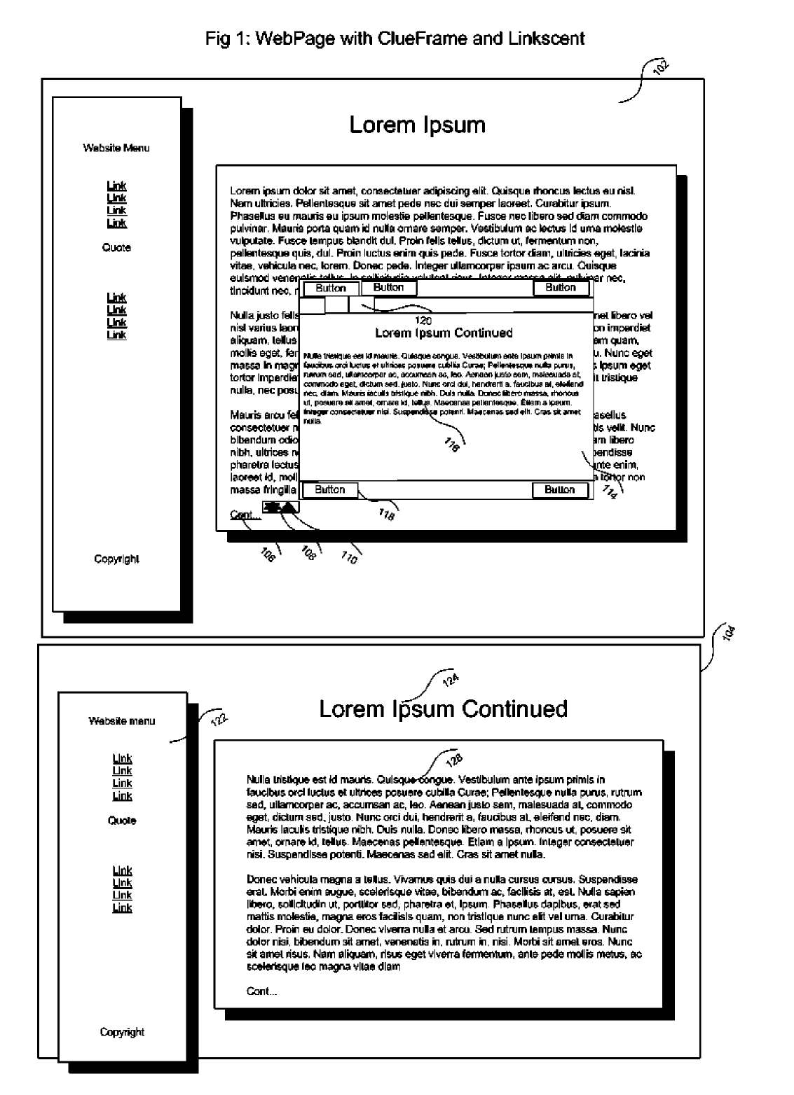

FIG. 1 shows two web pages, the referrer page 102 that the user is currently on, and the target page 104 that is the URL referred to by the active Link 106. A LinkClue Container 108 is placed next to the active Link, and it may contain various LinkClue Icons 110.

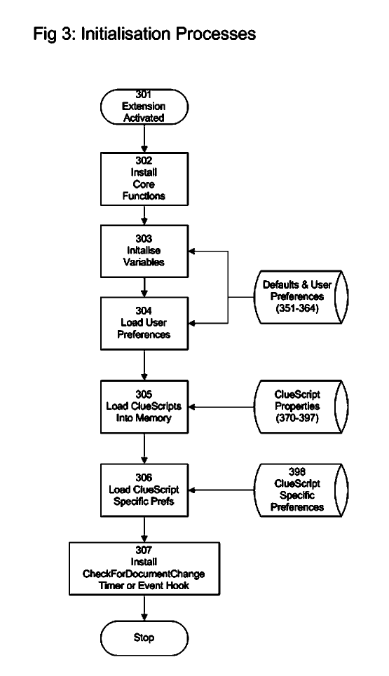

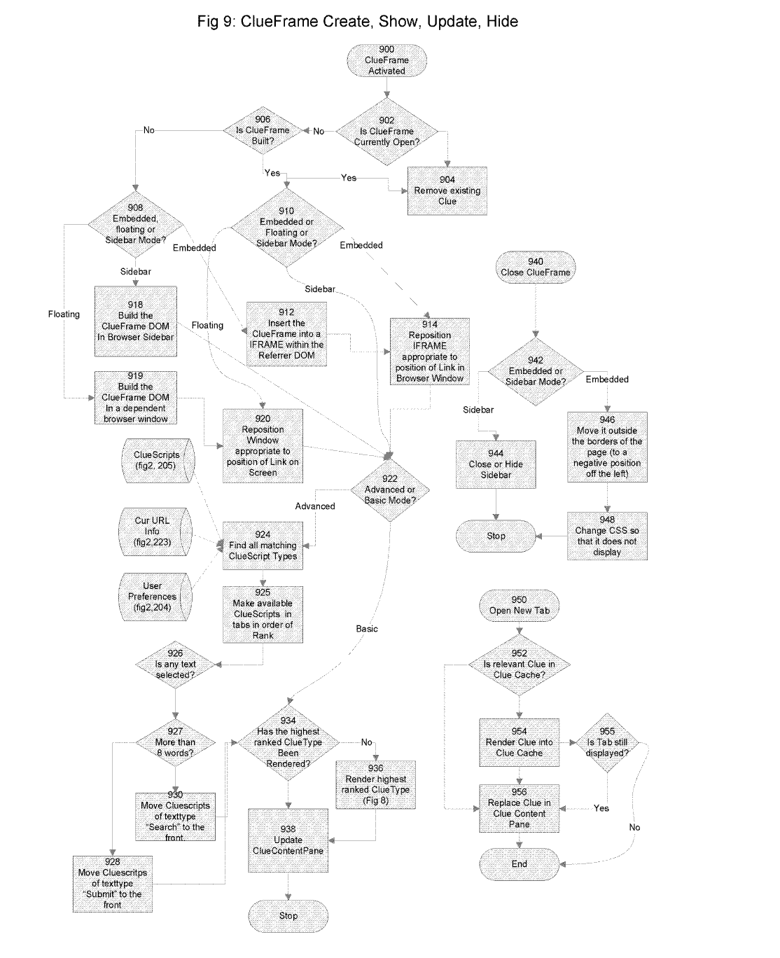

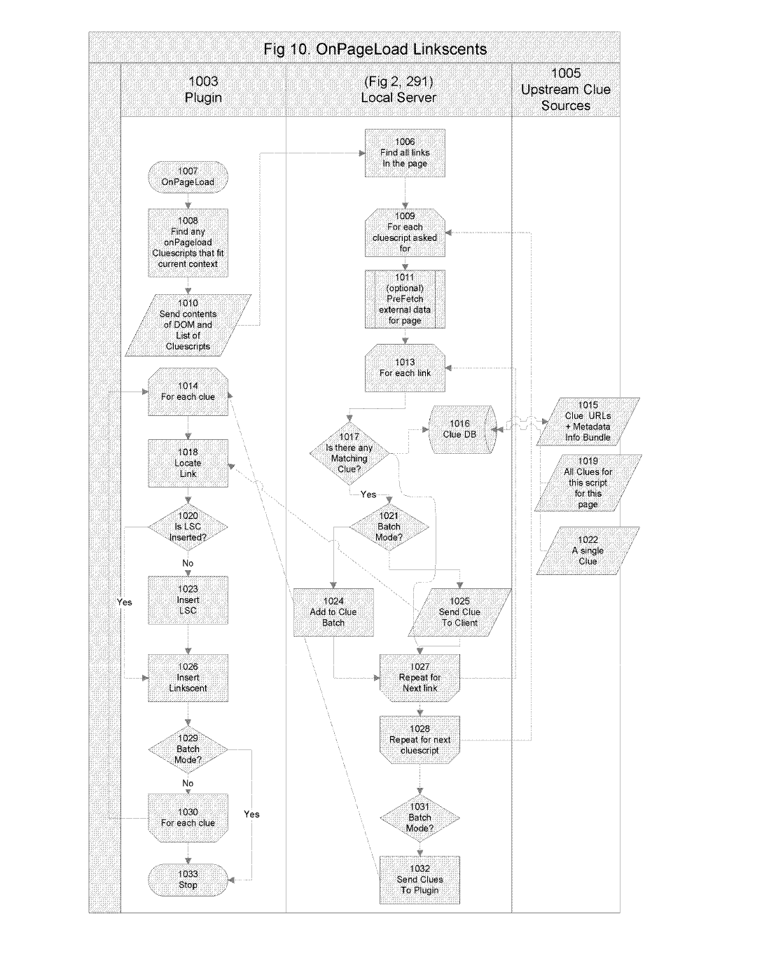

Assuming that the ClueFrameActivation Event (FIG. 3, 351) is onLSCHover, when the mouse pointer is placed within the LinkClue Container, the ClueFrame 114 appears (see FIG. 9), in this case displaying a document summary of the target link 115. The ClueFrame may have various buttons 118 and in an advanced embodiment there may be displayed within a tab bar 120 multiple tabs 116 each displaying content generated by their own ClueScript.

The Document summary shown is not a “preview” of the page content, but a dynamically generated page containing elements that may be of interest to the user. If page content 128 is shown it typically leaves out any navigation elements 122 on a page but attempts to capture details such as the title 124, the publisher, or the author. The main body content may be truncated according to a preference setting (FIG. 3, 360), or summarized using a text-summarization algorithm.

The ClueFrame may be instantiated either as an embedded block element within the DOM of the referrer page, or it may be instantiated as a floating window or in a Sidebar, in which it has it's own DOM (Document Object Model). This setting may be changed by the user, or automatically changed in response to conditions on the referrer page (e.g., a document frame being too small for an embedded ClueFrame, or large objects that may overlap the embedded ClueFrame).

FIG., 2 shows a Browser Extension 201 installed as an extension/plugin to a Web Browser Host Platform 202. For example, a BHO (Browser Helper Object) for the Internet Explorer Web Browser produced by Microsoft Corporation, or an XUL based extension for the Firefox Web browser produced by the Mozilla Foundation.

The web-browser 202 displays a referrer document 231 that links to one or more target documents 241. Neither target nor referrer documents or domains need have any special features, but they may have embedded directives which affect the behavior of the extension—for instance preventing the collection of some pages using a line in the domain's robots.txt file, or preventing the addition of LinkClues to any or all portion of a document by use of a CSS style sheet class, or by recommending the use of specific ClueScript(s) by way of a line in the target document headers.

In the preferred embodiment, the Host Platform 202 makes a Script execution environment 203 available to the extension, which allows for the creation of the extension Environment 210, provides access to Browser Event Hooks (such as when a new window or new browser tab is opened), exposes the DOM of a loaded page 235 to the functions in the extension environment, and also gives the functions within the Extension elevated security privileges so they may download information from the target domain 240, a master server domain, 270 and/or 3^{rd} party domains 280—privileges that would not normally be available to a script executing within the Referrer DOM 235.

Actions of the extension are governed by user preferences 204 and a set of ClueScript Definitions 205, which may be stored on the user's machine, compiled into the extension, or downloaded from an external server 273, 274 on initialization, which are activated by the ClueScript Selector Subsystem 218 and executed by the ClueScript Execution Subsystem 219. Optionally the user may choose to recognize cluescript suggestions and preferences assigned by the referrer in the document (231) or in a domain or directory pref file, eg domain.com/lnterclue.prefs (232), or cluescript and preference suggestions created by the target domain in the target file (241) or domain or directory pref file (242).

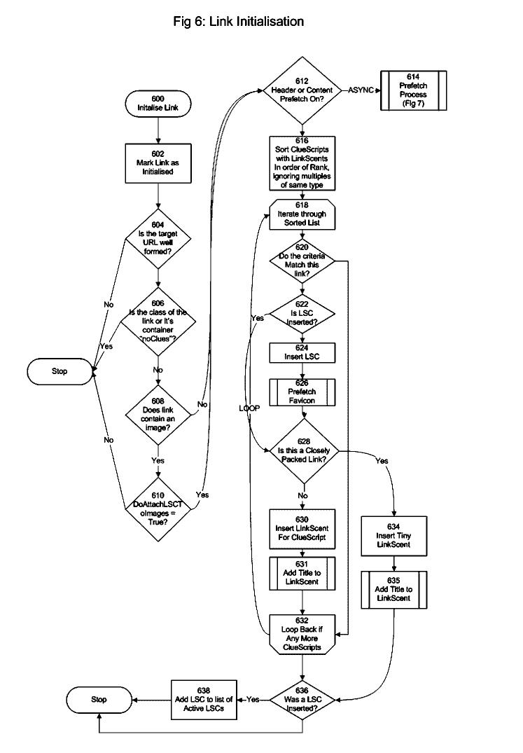

In the preferred embodiment, the CurrentLinkID 221 is updated when the onMouseHover 212 event is processed, and the ClueFrame displays 215 if the CurrentLinkID 221 has not changed, (usually indicating the user's mouse has paused on the link), otherwise the CurrentLinkID is updated to the currently active link object 236, or NULL, a LinkClueContainer may be inserted into the active link object (See FIG. 6), and the ClueFrame may be updated 216 or hidden 217. It is possible that the ClueFrame may need to be created 214 before it is displayed., in which case it may optionally take notice of preferences expressed by the referrer page (231) or domain (232), especially as regards theming.

In an alternative embodiment (not shown), EventHandlers are attached to the MouseOver and MouseOut events of each link, or LinkClue, if LinkClues are used, and these set the CurrentLinkID pointer to their LinkID when the mouse enters and clears it when the mouse leaves, and activate the ClueFrame if the mouse has hovered on a link or LinkClue for long enough.

In another alternative embodiment (not shown), the CurrentLinkID is not set on the onMouseMove event (237) but only when the timer times out. This requires that the browser is able to report the mouse position at the time that the browser times out, which is not possible with all browsers.

It is possible to get relevant data from other browser addons 251, or call relevant functions 252, from inside Cluescripts.

Alternatively, the browser itself may expose some relevant metadata 208 such as whether a link has been bookmarked, whether it is in the browser history, or whether it is actually open in another tab/window right now, (in which case it may be possible to highlight that tab or window for the user).

A problem created by the Clueframe relates to attention data. If you are looking at the clueframe you are arguably not currently paying attention to the current page. As a consequence of monitoring the mouse (237) one is able to detect when the user's cursor has shifted into a different Iframe on a page, or into the clueframe.

Traditional attention metrics only count pageviews, or time on a specific page, or site, but there is a problem with emedded interactive widgets such as the ClueFrame because although the Iframe is embedded into this page it's displaying content relevant to the target page, so the attention may end up being misrecorded.

So if one were to track the time spent on pages using an attention monitor (209), and store this information in a datastore (292) it is necessary to track both the time spent on a page and on the clueframe content related to that page. Since the Clueframe dissapears on mouseout it is safe to say that while the users's mouse is in there they are paying attention to it. Ideally, one will also store the sentence the user got up to in the clueframe, so that if they jump through the relevant point in the text can be highlighted or scrolled to, and their reading speed is not affected.

Conversely if an embedded movie is onscreen and active, the user is almost certainly paying attention to that, and attention data should not necessarily be counted towards the URL of the current page.

Another problem created by the Clueframe relates to recall. From time to time a user will bookmark a link before visiting it, and will want to know in the future whether they actually visited the link in question or whether they only saw the summary. This is partly the purpose of the Rich Bookmark Data (296) and the mechanism for creating it.

The attention store (292) is a record of time spent on different URLs, and distinguishes between time on the Clueframe and time on the page. Ideally it would also distinguish time spent watching embedded video clips, but this may not always be possible.

Often, a user will want to assign a particular link to a particular task or “intention” rather than visit it or simply bookmark it. This allows cluescripts to display information regarding the user's intentions towards a linked page using the standard cluescript mechanisms. In the case where upstream intention datat (298) is availably one may also see groupware or social informatin regarding specific links, by way of cluescripts.

A list of current intentions for rapid selection can be stored in user preferences (204) in a server datastore (294) or in an upstream datastore (296).

Hence an ideal bookmarking cluescript would allow the user to store into the Rich Bookmark Data store:
(1) Details of the URL
(2) Details of the URL it was linked from, if they saw it via a Clueframe for
(3) The time they spent on the page
(4) The point they got up to on the page
(5) How closely they read it (skimmed, read, studied) which can be automatically calculated from a and b, along with the word count and your average reading speed, meaning the user doesn't have to choose most of the time.
(6) Any attributes/ratings that they have decided to store regarding the page
(7) Any intentions they think the link is relevant to, which should be quickly selectable from a recency based list and which can also be calculated, allow the ability to figure out how much attention you paid to a page in a more.

So that when next viewing said link, the cluescript can inform the user that “You last saw this link on the 12th of July while planning your holiday, you arrived here from [a google search], you spent 2 minutes looking at it, [skimmed] [half way] down the page and marked it as [very] [interesting] and [somewhat] [expensive].

Applications regarding the aggregation and distribution of such data via an API (299) should be apparent to those skilled in the art.

FIG. 3 illustrates onActivate Processes, Cluescript and Preference Loading.

The onActivate process can occur either on browser startup, a defined number of seconds after browser startup, or when the user presses a button or otherwise indicates that they wish the extension to activate.

The extension is activated 301 and core functions are installed 302.

The user's preferences 341-364 may be stored within the browser extension or on a profile server (273) which the user logs into during the initialization process.

In the preferred embodiment, the following properties are initialized to defaults or set to the user's preferences.

| | Variable | Default Value | | Alternatives |
|---|---|---|---|---|
| 341 | PrivateURIs | “*127.0.0.1*, *https:, | | |
| | | 10.*.*.*, 192.168.*.*, | | |
| | | 127.0.0.1, localhost,” | | |
| 342 | ClueButtons | “ThisTab, NewTab, FontUp, | | Anything buttons that have been |
| | | FontDown, SendEmail” | | installed with functionality as |
| | | | | described in 3000-3006 |
| 351 | ClueFrameActivateEvent | onLSCHover | | onLSCClick, onLinkHover |
| 352 | HoverTime | 200 | ms | |
| 353 | DoFaviconPrefetch | True | | False |
| 354 | MaxFaviconsToFetch | 50 | | |
| 355 | DoLSCFadeOut | True | | False |
| 356 | LSCFadeTime | 1000 | ms | |
| 357 | DoHeaderPrefetch | True | | False |
| 358 | DoContentPrefetch | True | | False |
| 359 | ContentFetchTimeOut | 15 | s | |
| 360 | MaxSummaryWordCount | 300 | | |
| 361 | ClueFrameHideDelay | 300 | ms | |
| 362 | ClueFrameOffSetX | 10 | px | |
| 363 | ClueFrameOffSetY | 10 | px | |

| | | | |
|---|---|---|---|
| 364 | DoAttachLSCToImages | True | False |
| 365 | LinkClueModeForHTTPS | Off | SmartScent, ExternalLinksOnly, On |
| 366 | LinkClueModeforHTTP | SmartScent | On, Off, ExternalLinksOnly |

Once user preferences are loaded 304 clue scripts and clue buttons 305 are d into memory.

Cluescripts described by 370-396 and 4000-4008, and clue buttons described by 3000-3006 may be executed most rapidly if they are available from memory rather than disk or an external server, so if possible they should be loaded into memory at this point.

The following items define a cluescript 370-396. Cluescripts may be loaded from disk, compiled into the extension, or loaded from an external server. Ideally, a user loads a list of cluescripts and their locations within their preferences, and downloads the latest versions, if any of the local copies of said cluescripts after logging into their profile server (not shown).

The ranking of the ClueScripts may be determined by a fixed list, or ordered by the user. In an advanced embodiment, ranked lists of ClueScripts may be distributed and inserted into individual extensions.

370: id [alphanumeric string][required]: unique identifier for this ClueScript. May only contain alphanumeric characters as it will be used for naming files and folders

371: name [string][default=id]: Human readable name for the cluescript used in user output when referring to this clue. If not given then defaults to the cluescript id 370.

372: help [html string][default=″″]: Help text to explain how a particular cluescript works. May contain {SubstitutionVariables}

373: type [string][default=″″]: Some ClueScripts show similar types of information, the scripts may be of varying quality—for instance an on-demand heuristic summary will usually be of poorer quality than a custom built content summary. Having multiple versions available allows for a failover process.

374: quality [int][default=0]: If more than one ClueScript of the same type (373) is available then the ClueScript with the highest quality will be fetched first, and if unavailable will failover to lower quality versions.

375: includeUrls [array of RegularExpressionStrings][default=[http://*″]]: The target link destination URL must match at least one of these regular expressions for the ClueScript to be valid for this link.

376: excludeUrls [array of RegularExpressionStrings][default=[] (empty array)]: The target link destination URL must not match at least one of these regular expressions for the ClueScript to be valid for this link.

377: requestHeaders [boolean][default=false]: If “true” then the cluescript will pause before downloading the contentUrl, and check the mimeType against the mimeTypes lists (378) and retrieval will be halted if the mimetype doesn't match at least one of the given types.

378: mimeTypes: [array of RegularExpressionStrings][default=[′text/*′]]: Only used if requestHeaders 377=true.

379: maxContentLength : [int][default=(64*1024)] (64kB): Maximum length of content to retrieve from contentUrl. If content length exceeds maxContentLength the retrieval will be halted and the partial content will be returned.

380: maxContentToParse : [int][default=0 (no limit)]: Maximum length of content to parse after retrieving it from contentUrl. If content length exceeds maxContentToParse then the html will be truncated to maxContentToParse before being first rendered.

381:LinkClueTooltip [string][default=″″]: Tooltip text for the LinkClue icon, which may appear on mouseover, or in a hintbox at the top of the Clueframe. May contain the following SubstitutionVariables:
{innertext}: current links innertext
{plainLocation}: plaintext url of the current document
{plainUrl}: plaintext destination url of the link
{plainDomain}: plainText domain of the destination of the current link
{filename}: filename of the links destination

382: staticContent [string—full html][default=″″]: If set then no content will be retrieved instead the static content will be parsed and displayed. staticContent may contain SubstitutionVariables

383: framed [boolean][default=false]: If true then no content is retrieved, instead the content consists of an <iframe> tag who's src attribute is set to the contentUrl. note: we cannot access the content of this frame, nor can it access anything beyond itself. This is a safe way of displaying 3rd party content.

384: LinkClueOnly [boolean][default=false]: if true then no tab will be created for this ClueScript, it will only be used to display a LinkClue icon.

385: icon [string][default=′. . ./defaulticon.png′]: The url of the icon that the ClueScript will use for LinkClues and also for the Tab icon in Advanced Mode. The URL can be relative to the ClueScript directory, or an absolute URL.

386: dynamicicon [function][default=false]: Sometimes an author will want more control over which LinkClue/tab icon to display. In this case the author can create the dynamicicon function. Then function must return a path + filename relative to the clueScript file that points to the correct icon. If the function fails or throws an error then we fall back to the ClueScript's icon property.

387: LinkClue [string][default=‘onHover’][‘never’, ‘onHover’, ‘onPageLoad’]: The suggested time to display a LinkClue for this ClueScript. In an advanced embodiment this property can be overwritten by a user on a per ClueScript basis:
‘never’: No LinkClues should be applied for this clue. Often used when the clue matches so many links that it adds little information to show a LinkClue. ‘onHover’: Hide this LinkClue until the user mouses over the link.
‘onPageLoad’: Investigate to find out if there are any LinkClues of this type to show for this page on PageLoad, and display them semi-transparent next to the links until the onMouseHover event.

388: contentUrls [array of strings][default=‘{plainUrl}’]: The url(s) from which to retrieve content for a given clue. The contentUrl(s) may contain SubstitutionVariables as follows, to be replaced at RunTime when calculating the URL:
{plainUrl}—destination url of link
{plainLocation}—url of document the link is on
{filename}—filename part of url
{innertext}—of link
{innerHTML}—of link
{domain}—uriencoded destination domain of link
{userld}—unique id of the current user

By default contentUrl(s) is {plainUrl} which is simply the target URL of the link.

389: contentSafe [boolean][default=true]: If false then the contentUrl will be checked for unsafe words before any content is retreived. If an unsafe word is found then the content will not be retreived. The user may override the block on a per url or per domain basis.

390: platforms [string][default=‘firefox, siteclues, winclues, ietoolbar’]: A comma separated list of platforms the clue is valid for. If the platform is not on the list the clue will not be installed.

391: cache [boolean][default=true]: If cache=false this prevents caching of content retrieved from contentUrl 388. If a cluescript has no contentUrl then cache is always false.

392: substitutes [object][default=false]: Allows the ClueScript author to define their own SubstitutionVariables for use in calculating contentUrl 388 and dynamicicons 386.

393: isValid() [function][default=false]: When includeUrls 375, excludeUrls 376 and mimetypes 378 are not enough. For when an author needs specific criteria to calculate if a particular link is valid for the clue. The isValid() function is passed the current link as it's first argument. It must return [true] if the link is valid or false if not. If an error occurs whilst processing the function then isValid() will return false and no error will be thrown.

394: templateFile [string][default=″″]: If set then this clue will attempt to load the template filename from it's localUrl and use it as this clue's templateHTML 395. If the file is missing or empty then the clue will throw an error and fall back to using the default template HTML.

NOTE: if the template file is a full html page then only the html within the <body> section will be used as the templateHTML. if the template is an html fragment then the entire fragment will be used.

templateHTML [string][default = see example]:
templateHTML :
<html>’+
<head>’+

<title>{innerText}</title>
{defaultStylesheet}

</head>
<body>

<div id=“header”>{pagetitle}</div>
<div class=“content”>{content}</div>
<div id=“footer”>{footer}</div>

</body>
</html>

The default template is shown above, each of the TemplateVariables will be substituted before the content is shown. note: to make editing a template easier a cluescript author may make a separate template.html file which must be located in the same directory as the cluescript and must be named “template.html”.

396: templateVariables [object][default=false]: A list of variables to be substituted in the template. The default template contains
{innertext}
{defaultStylesheet}
{pagetitle}
{content}
{footer}

Additional variables can be used if a custom template file is used. Each TemplateVariable can be any of the following
a string containing SubstitutionVariables (e.g. “Google Search results for {inner Text}”)
a string containing Substitution Variables from another script, e.g. {othercluescriptname.variablename}, wherein the variables will be replaced and the result will be inserted into the template for display;
a css selector (e.g. “div#content”, “.description” or “body -table.footer”);

All elements that match the selector will be found and their outerHTML (the element and it's content) will be displayed. note the use of a negative selector (e.g. “body -table.footer”) will select the body element but will remove all tables with class=“footer” before returning as content.

or a function, e.g.
templateVariables : {

tickettype : function(clue){

var headings = clue.document.getElementsByTagName(‘h1’);
if (headings && headings[0].innerHTML.indexOf(‘(’)){

return headings[0].innerHTML.replace(/\hat{ }.*\(|\).*$/g, “);

}
else {

return ”;

}

}

}

The function will be passed the entire clue object which can be used to calculate the content to return. the clue object has additional properties:

clue.document : the document object created from the html retrieved from the contentUrl

clue.link : the current link that the clue is connected to.

Again the function is wrapped in a try-catch block and any error that occur will merely result in no content being returned and a warning send to the debuglog.

397: ValidationPrecheckFunction [string][default=″″]: After the ContentURL is downloaded but before the script is executed, the ClueScript will execute this function to confirm that the content is valid for this ClueScript—usually this would involve looking for a “signature” that identifies the content as being generated by a specific content management system.

398: TextType [string][default=″″]: If TextType=“Search” then this Cluescript will be activated when the user selects 10 words or less. If TextType=“Submit” then this Cluescript will be activated when the user selects 11 words or more.

399: ExecutelmmediatelyinClueframe [boolean][default=“no”]: If True, it will run this cluescript immediately on opening the clueframe, regardless of whether it has the foreground.

4000: DependentOn: [ClueName], [BodyRegEx] [default=″″: If set, and in advanced mode, this cluescript will only execute after [ClueName] has executed and the page content of ClueName has been found to include BodyRegEx.

4001: Developer: [default=“unknown”]: The author of this Cluescript.

4002: VariableSharing: [default=“private”]: If “private” then template variables are only available to this Cluescript. If “shared=foo” then the are available to any Cluescript belonging to developer “foo”, if “public” then all Cluescripts may make use of the template variables for this Cluescript when they execute

4003: cursor: [default=″″]: Filename of the cursor that should be displayed when the user mouse over the link. Mainly useful for LinkClues which do not have active ClueFrames.

4004: nanoHint [function][default=empty function]: nanoHint : function(clue, link){

if (link && link.filename){

return “NanoHint : ”+ unescape(link.filename);

}
else {

return “;

}

}

Allows a clue to add data to a special titlehint for this particular link. (titlehint will eventually become a nice DHTML tooltip, at the moment we are just using the links “title” attribute).

geolocation [object][default = null]
geolocation : {

long : 42.3,
lat : 128.7,
radius : 4

}

An object that specifies the location where the clue is relevant, if the page lies within this location the is considered

onFirstLinkClickAction [function][default = null] :

onFirstLinkClickAction : function (evt, link){

return confirm(“Are you sure you want to view this PDF?”);

}

If specified then this action will take place before the event is passed to the link (and normal browser navigation takes place). if onFirstLinkClickAction returns false then the event will be cancelled, otherwise the event will flow through to the link.

onLaterLinkClickAction [function][default = null]:

onLaterLinkClickAction : function (evt, link){

alert(“Sorry you have chosen to never view PDF files!\n

I can't let you do that, Dave.”);

return false;

}

onFirstLinkClickAction must be specified for this to be valid. If specified then this action will take place before the event is passed to the link on any subsequent clicks. Again the function must return TRUE (allow event to pass through), or FALSE (halt event).

4008: DoNotShowForCurrentPage [boolean][default=false]: —some clues may not be useful if they are shown relevant to the current page (in a browser sidebar or page insert) as opposed to a target item. This may also be determined via the validation precheck (397).

3000: Add list of Clue Buttons: Each ClueButton may be defined as follows

3001: id

3002: description

3003: action

3004: icon

3005: location

3006: visibility—a function which determines the circumstances under which the button should appear, for instance some buttons may not be appropriate within some user agents.

Below is an example. Note that this button collects and formats data for submission to a bookmarking service from within the clueframe, which is a novel step in itself. A similar script could pass this information out to the user's email program.

{

id : ‘delicious’,
description : ‘{clueframe.button.delicious}’,
action : function( ){

var URL_MAX_LENGTH = 2000;
var doc = Klib.ClueFrame.contentFrame.doc;
//use selected text within content frame
var notes = doc ? Klib.getSelectedHtml(doc) : “;
var destUrl = Klib.Clue.currentClue.link.href;
var title = Klib.Clue.currentClue.getTitle( );
var url = ‘http://del.icio.us/post?v=4;noui=yes;jump=close;url=’+

encodeURlComponent(destUrl)+‘;title=’+encodeURlComponent(title)+‘;notes=’+encodeURlC
omponent(notes);

//trim url to max length
url = url.substr(0, URL_MAX_LENGTH);
var win = new Klib.KWindow(‘AllTheCluesDelicious’);
win.useChromeDialog = false;
win.open(url, 700, 400);

},
icon : ‘delicious.png’,
location : ‘titlebar’,
visibility : function( ){

return (Klib. platform != ‘winclues’);

}

});

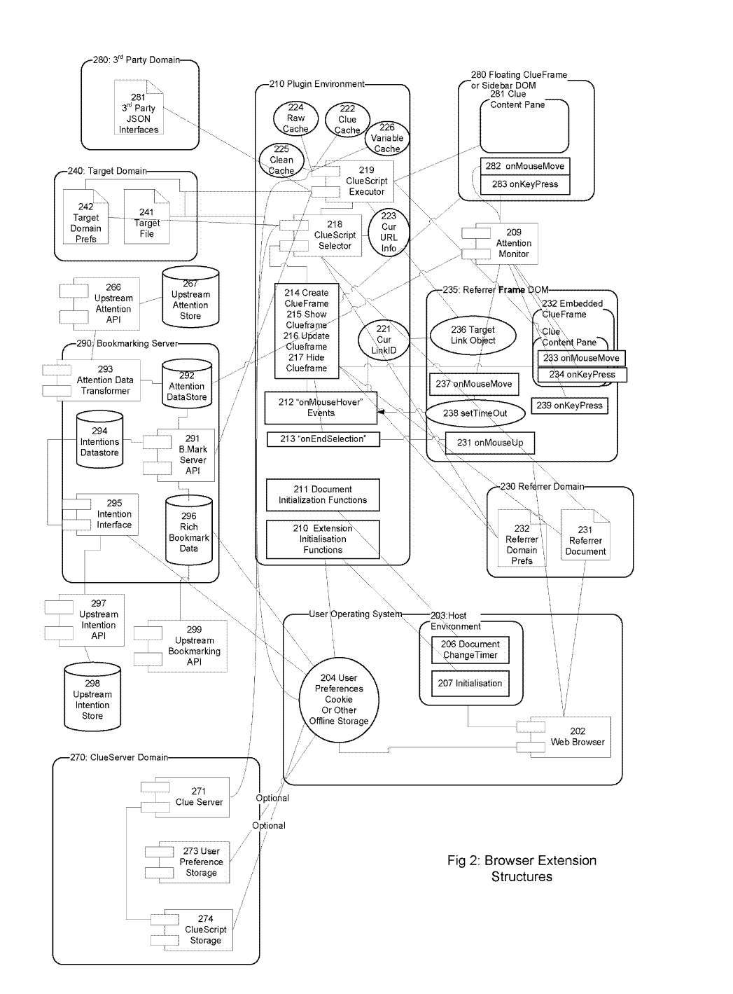

306: Add User's ClueScript Specific Preferences: The user's ClueScript preferences 398 are a subset of the user preferences (FIG. 2, 204) that may be stored within the browser extension, or in a profile server which the user logs into during the activation process. These preferences overwrite the properties 370-396 of the loaded ClueScripts.

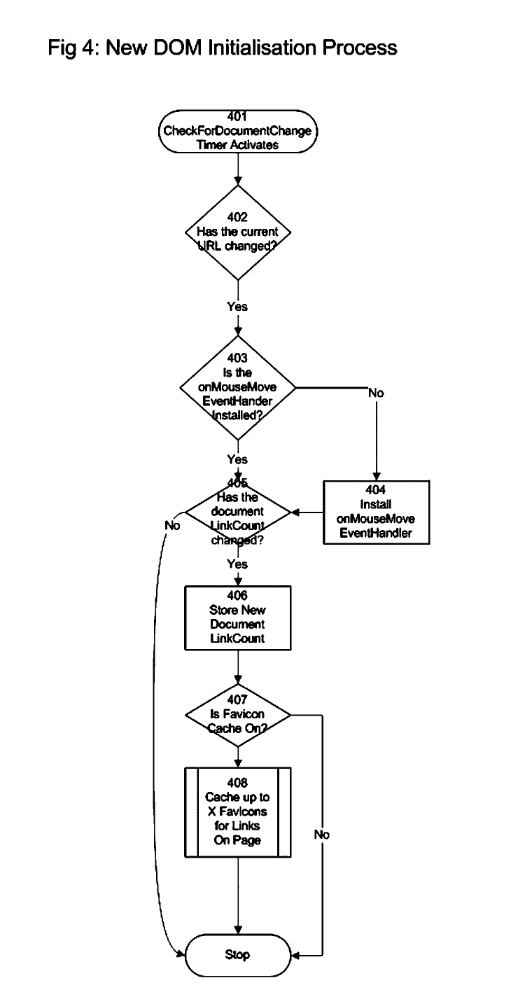

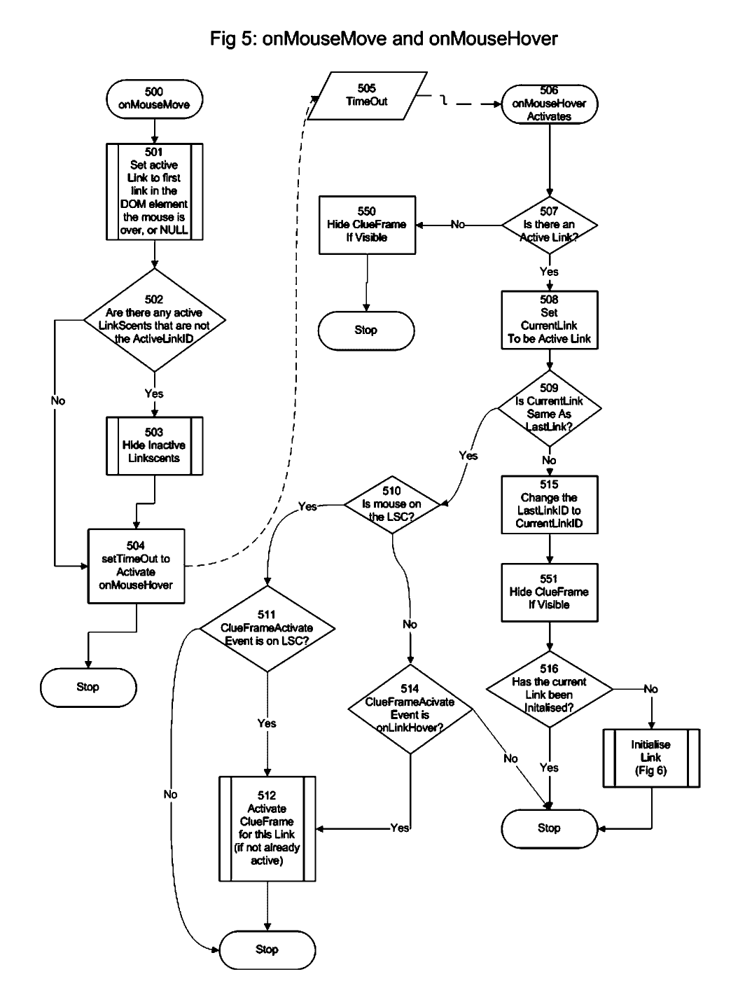

307: Install CheckForDocumentChangeTimer: This Timer (FIG. 2, 206) runs within the browser scripting/event environment (FIG. 2, 203) and its operation is disclosed by FIG. 4.

FIG. 4 illustrates onDocumentChange Processing.

401: The timer (FIG. 2, 206) installed in step (FIG. 3, 307) executes several times a second, to see if the document has changed 402. If so the document initialization functions (FIG. 2, 211) are executed as follows:

(An alternative embodiment might use a browser event hook which is activated on every change of displayed URL and/or the active DOM).

403: Check the HasBeeninitialisedFlag (not shown) to see if the page has been initialized at least once, set the HasBeeninitializedFlag, if it hasn't been yet, and attach the onMouseMove Event 404. (In an alternative embodiment, onMouseMove event may be attached to the browser or the window object as opposed to the document, in which case step 404 is not needed.)

405: Has the number of links changed? If not, quit, otherwise store the new linkcount for the document 406.

407: Is the Favicon Cache on? If so iterate through the links on the page 408 and prefetch up to MaxFaviconsToFetch (FIG. 3, 354) favicons from URLs calculated from the domain portion of the links on the page with/favicon.ico on the end of the URL. E.g. if there is a link to http://foo.com/baz/bar.html we would prefetch http://foo.com/favicon.ico if it was available. This has the additional benefit of forcing the user's system to perform a DNS lookup on “foo.com” which speeds up future operations. An alternative embodiment might simply do a DNS lookup for each domain, but fetching the favicons adds more value for very little extra bandwidth.

409: Is HEAD prefetch enabled? If so iterated through the links on the page and do a HEAD request for each linked item (or up to a certain number or a certain number for each domain in a similar manner to 407), storing the results in the “clean” cache (224)

410: Are there any dependent frame or Iframes in this document? If so, repeat from 403 for them.

FIG. 5 illustrates Link Selection Process.

500: The onMouseMove event is initialized

501: The onMouseMove event, created on the DOM (FIG., 4 404) sets the ActiveLinkID (not shown) to be the link the mouse is currently resting on, or NULL if the mouse is not resting on a link. It then checks 502 the list of active LinkClues (FIG. 6, 638) and hides any 503 that are not the ActiveLinkID. It then executes a setTimeOut operation 505 for the HoverTime which means that if the mouse has not moved again and the document is still active, the onMouseHover event will activate.

506: The onMouseHover event is activated.

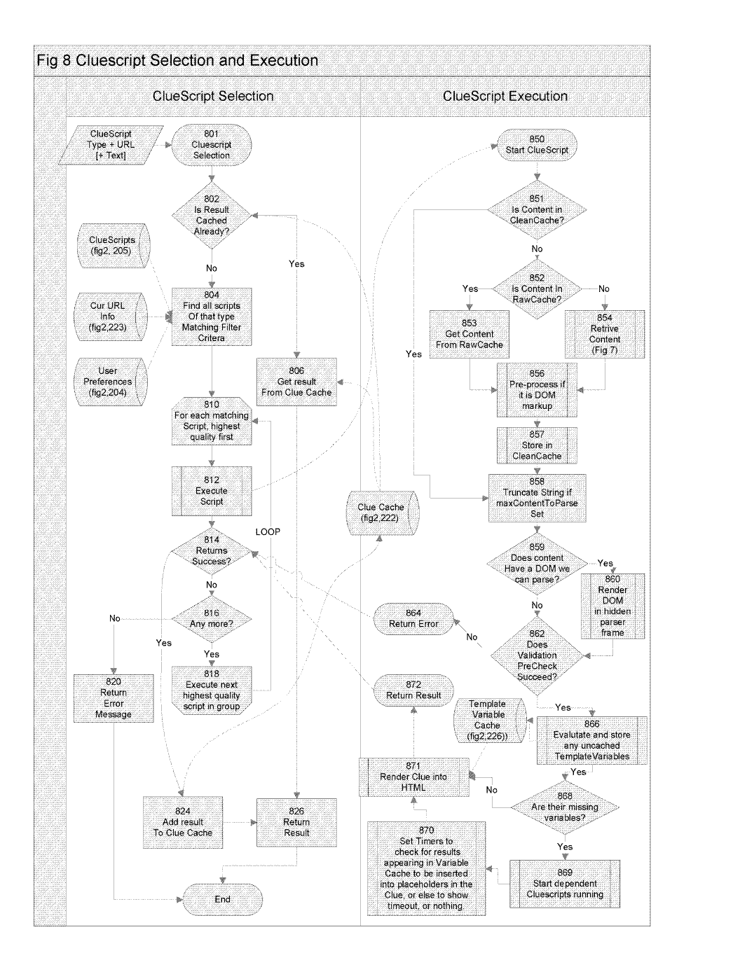

If the ActiveLinkID is null 507 then hide any visible ClueFrame 550 otherwise set the CurrentLinkID 508 to be the ActiveLinkID. If the CurrentLinkID is the same as the LastLinkID 509 then the mouse has stayed on the current link for the HoverTime, and should be processed. The mouse may be resting on the LinkClueContainer (not shown) within the Link element 510, in which case if the ClueFrameActivateEvent is set to onLSC 511 the ClueFrame should activate (FIG. 8, 802) unless it's active already.

If the mouse is not resting on the LSC but on the link itself, and the ClueFrameActivateEvent is onLinkHover 514 then activate the ClueFrame (FIG. 8, 802) unless it already is.

If the CurrentLinkID is not the same as the LastLinkID 509 then change the LastLinkID to be the CurrentLinkID 515, hide any visible ClueFrame 551 because h a new link will be initialized.

If the current Link has already been initialized 516 stop to see if the mouse stays on this link long enough to activate the ClueFrame. Otherwise initialize the link (FIG. 6, 600).

If the mouse lifts 520 and text has been selected 522, then the user can indicate wanting to see the ClueFrame 524 by mousing over an icon that is inserted 523 before or after the text. If more than a set amount of words (E.g. 8) were selected 525 then the clues of texttype=“submit” (FIG. 3, 398) then those clues should be shown if it's in advanced mode. If not, only the highest ranking one that matches is shown. If fewer than the set amount of words were selected then the first to appear are those with TextType=“search”. But either TextType may usually be used with more or fewer words.

FIG. 6 illustrates Link initialization.

602: Mark the link as initialized.

604-610: Check if the link is eligible for LinkClues.

For instance, if the link contains an <img> element and images-based LinkClues are turned off in the user preferences, or the link is in a block that has a class=“noclues” attribute, or the link is not well formed, it will be ineligible for LinkClues.

612: If the user is preFetching document headers or content (FIG. 3, 357, 358) then start the prefetch process 614.

616: Sort available ClueScripts with LinkClues by rank, and ignore those without LinkClues and multiple ClueScripts of the same type.

618: Iterate through the list, checking if the criteria match the current Link 620. When the first one that matches is found, insert 624 the LinkClueContainer (LSC).

The LSC may be inserted at the beginning or end of a hyperlink, or in an advanced embodiment, both, or with some icons appearing before and some after.

In this embodiment, the LinkClue container is inserted into the <A> element right after the last text/image found in the element.

<a href=“{targetURL}”. . . >{TargetLinkText}{LSC}</a>

One possible LSC is a <SPAN> element wrapped in another SPAN used to ensure correct positioning. A variety of CSS attributes are used to encourage correct behaviour and appearance of the LinkClues. Other embodiments are possible and may become necessary as browsers change how they render HTML and CSS.

<SPAN style=“border: medium none ! important; margin: Opt ! important; padding: Opt ! important; background: transparent none repeat scroll 0% ! important; overflow: visible ! important; float: none ! important; -moz-background-clip: -moz-initial !important; -moz-background-origin: -moz-initial ! important; -moz-background-inline-policy: -moz-initial ! important; text-indent: Opx ! important; max-width: none ! important; min-width: Opt ! important; max-height: none ! important; min-height: Opt ! important; white-space: nowrap ! important; position: absolute ! important; display: inline; height: 16px ! important; width: Opx ! important; z-index: 100! important;” class=“LinkClue_positioner”>.

<SPAN title=″″ style=“border: medium none ! important; margin: Opt ! important; padding: Opt ! important; background: transparent none repeat scroll 0% ! important; overflow: visible ! important; float: none ! important; -moz-background-clip:-moz-initial ! important; -moz-background-origin: -moz-initial ! important; -moz-background-inline-policy: -moz-initial ! important; width: auto ! important; display: inline; text-indent: Opx ! important; max-width: none ! important; min-width: Opt ! important; max-height: none ! important; min-height: Opt! important; white-space: nowrap ! important; position: absolute ! important; height: auto ! important; z-index: 101 ! important; bottom: Opx ! important; left: Opx ! important; opacity: 0.99;″>.

{LINKCLUES GO HERE}

</span></span>

626: Prefetch the Favicon of the target URL, if it has not been prefetched already.

628: Check to see if the link is closely packed—as in right next to another link, such that the ordinary size LinkClue may make the other link unclickable. For example, if the LSC is to appear to the right of the link (the default) then calculate the display rectangles of the target link and the link directly after it in the DOM. If the bottom of their rectangles has the same offset and the further edge of the adjacent link is within the packing limit (e.g. 40pixels), then they are “closely packed” links. Optionally, A similar process for the prior link may be followed also to keep things even. This need only be calculated once.

If they are not closely packed, larger LinkClue icons can be inserted 630, insert the full size LinkClue Icon into the LSC. Due to potential conflicts in CSS style attributes, each LinkClue may be wrapped in it's own SPAN and given various CSS attributes to force appropriate appearance and behaviour. Here is a sample HTML for a LinkClue icon, this one being the default, which shows the favicon of the domain once it has been determined that it is available 626:

<span style=″border: medium none ! important; margin: Opt ! important; padding: Opt ! important; background: transparent none repeat scroll 0% ! important; overflow: visible ! important; float: none ! important; -moz-background-clip: -moz-initial ! important; -moz-background-origin: -moz-initial ! important; -moz-background-inline-policy: -moz-initial ! important; width: auto ! important; height: auto ! important; display: inline; text-indent: Opx ! important; max-width: none ! important; min-width: Opt ! important; max-height: none ! important; min-height: Opt ! important; white-space: nowrap ! important; position: static ! important; z-index: 102 ! important;”>

<img src=“{TargetDomain}/favicon.ico” style=“border: medium none ! important; margin: Opt ! important; padding: Opt ! important; background: transparent none repeat scroll 0% ! important; overflow: visible ! important; float: none ! important; -moz-background-clip: -moz-initial ! important; -moz-background-origin: -moz-initial ! important; -moz-background-inline-policy: -moz-initial ! important; display: inline; position: static ! important; text-indent: Opx ! important; z-index: auto ! important; max-width: none ! important; min-width: Opt ! important; max-height: none ! important; min-height: Opt! important; white-space: nowrap ! important; width: 16px ! important; height: 16px ! important; opacity: 0; visibility: hidden;” border=“0” height=“16” width=″16″>

</span>

In the case where the link is closely packed, insert a smaller version of the LinkClue (e.g. 8×8 pixels) 634 and do not bother adding any more.

635, 631: If the ClueScript has a value set for the LinkClue title (FIG. 3, 381) then generate the Title using the substation variables, and insert it as the title attribute on the <img> of the LinkClue.

If an LSC was inserted, add it to a list of active LSCs (This will usually only have one item in it) which is only used for the purpose of fading them out (FIG. 5, 502).

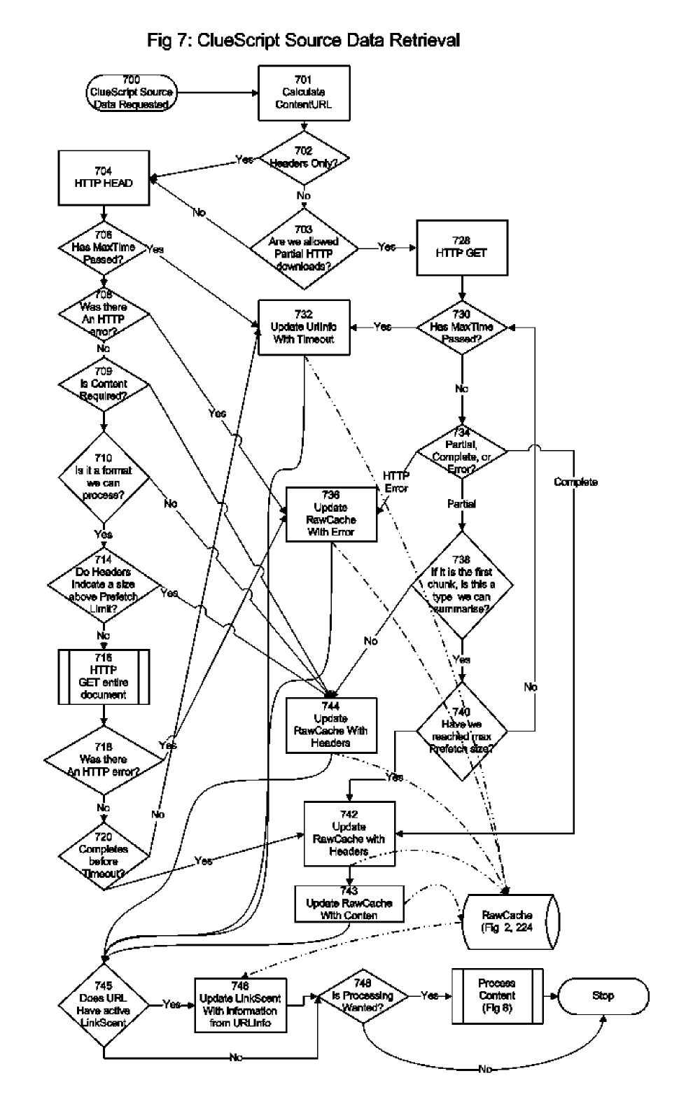

FIG. 7 illustrates ClueScript Source Data Retrieval

These steps may be called as part of the Link Initialization Process (FIG. 6 ), or, in an advanced embodiment (not shown), as part of a pre-caching process after PageLoad.

The task is to calculate the appropriate content for a ClueScript to operate on for a specific URL, and then fetch it according to rules in the ClueScript.

Info about the ContentURL is gathered and stored within the RawCache (FIG. 3, 352).

701: The ContentURL is calculated by inserting the value of the substitution variables given in the contentURL string (FIG. 3, 388).

702: The request may be to only check the headers of the ContentURL 702 in which case proceed to 704. Otherwise behavior must be changed depending on the platform in use.

Modern browsers incorporate an object available via scripting languages that fetches content in the background. In Firefox and Internet Explorer this is the xmlHttpRequest object. Different implementations of this object have different limitations. One of particular interest is whether it allows viewing of the results of a partial download. The xmlHttpRequest object in IE6 does not allow this, the native method in Firefox 1.5 does. The optimal process for prefetching content depends on this point, so in step 703 this determination is made, usually by way of simply checking a variable set when building the extension for a particular browser.

The optimal path for browsers which do not allow partial downloads is to first download the HTTP headers of a document using an HTTP HEAD request 704, with a timeout set so that after TimeOut seconds if the request is incomplete 706 it will set the timeout flag on this URL 732. It is also possible that the HEAD request will terminate with an HTTP Error 708, (e.g. error 404—Page Not Found).

709: If the request was for headers only, we can stop after the successful HTTP HEAD request and proceed to 732, otherwise:

710: After downloading the content inspect the MimeType header and compare against the valid mimetypes for this ClueScript (FIG. 3, 378) in which case further processing can continue, if it is of a size below the maxContentLength (FIG. 3, 379). 716: execute an HTTP GET against the ContentURL. If there is an HTTP error 718 then flag that 736 otherwise wait to see if it times out 720, if so set that flag 732, if not then save the information in the URLInfo object 742 and RawCache 743.

The optimal path for browsers which can perform partial downloads (e.g., Firefox) is to start with an HTTP GET 728 and on each state change 734 in the HTTP object, set the error value 734 if there was one, check the Mime Headers against the list in the ClueScript's mimeTypes list (FIG. 3, 378), if it's the first chunk 738 to determine whether to continue downloading or abort and save the header info 744. If the downloaded content reaches the maxContentLength (FIG. 3, 379) then save the information that is obtained so far 742, 743 and move on.

After the fetch is complete, has timed out, or ended in an error, the LinkClue should be updated 746 if there is a LinkClue for the ClueScript in an active LSC for the link 745. This may involve adding a LinkClue icon reflecting the error number, or a timeout, or increasing the opacity of the LinkClues or the LSC to indicate that the source information has been downloaded.

If further processing (which may be CPU intensive) is wanted at this stage (748) then ClueScript processing may begin from (FIG. 8, 850).

FIG. 8 illustrates ClueScript Selection and Execution.

Given a request for a specific type of metacontent (ClueScriptType) for a specific URL or text selection, the ClueScriptSelector (FIG. 2, 208) first 802 checks to see if there is an item in the ClueCache (FIG. 2, 222), and if so 806 returns that 826, but otherwise selects 804 those ClueScripts from the list of initialized ClueScripts (FIG. 2, 205) with criteria matching the Current URL (FIG. 2, 223) and the User Preferences (FIG. 2, 204). It then iterates 810, 812, 814, 816, 818 through these ClueScripts in order of decreasing quality (FIG. 3, 374), executing each in turn 812 until one successfully returns a result rather than an error 814.

If no ClueScript returns positive, an error is returned 820 otherwise the result is added to the ClueCache 824 and returned 826 to be displayed to the user.

If the existing content URLs (FIG. 3, 388) are not in the Cleancache (FIG. 3, 351) or RawCache (FIG. 3, 352) then they are retrieved 854, in parallel or serial, according to the process in FIG. 7, and then text processed 856 if they are HTML or another serialized DOM format (e.g. XML), typically using regular expressions, to remove potential security hazards before rendering the DOM, and then headers and/or content are stored in the CleanCache 857.

Before DOM processing 858 the value in maxContentToParse (FIG. 3, 380) is checked, and if necessary the content is truncated prior to being rendered, to prevent an overly time consuming rendering process.

If the content allows a DOM to be built from it 859 it is rendered in a hidden Parser frame 860.

Now it is possible to run the Validation Precheck (FIG. 3, 398) if present, to ensure that the document and context meet the pre-conditions for the ClueScript to successfully execute.

The next step 866 is to evaluate the content for the TemplateVariables (FIG. 3, 396) for insertion into the TemplateHTML.

In some cases template variables from other Cluescripts may not be available from the cache. Rather than quitting, or waiting for the cluescript to execute, the dependent Cluescripts are started 869 and placeholders put into the Clue output HTML 871 that will be automatically replaced by timers 870 which are checking regularly for the necessary content from cluescripts 869 to execute.

FIG. 9 illustrates Clueframe Process.

When a ClueFrame is activated to display metacontent for a URL 900, it may be already open 902 in which case it is a simple matter 904 of replacing the current metacontent, if any, with information from the ClueCache (FIG. 2, 222) and/or updating any user interface elements using the UrlInfo (FIG. 2, 223) object.

Otherwise it must be determined whether the ClueFrame is currently available to be repopulated with information, or whether 906 it must be constructed first.

If constructed in an embedded window or Sidebar, the ClueFrame either consists of standard HTML+CSS content, or in an alternative embodiment (not shown) a Flash, java, or activeX object, or any other interactive format available in a browser environment. In floating window mode, the ClueFrame is usually rendered similarly, inside a browser window opened using browser scripting, but could be rendered using a separate application (not shown) in an advanced embodiment, opened via COM or some other inter-application communication method.

In either basic or advanced mode, the ClueFrame consists of a ClueContentPane, rendered as a DIV containing an IFRAME in the current embodiment, and control pane(s), rendered using separate DIVs in the current embodiment. Due to limitations in current browsers it may be necessary to add a dynamic resizing process that changes the size of the IFRAME when the ClueFrame is resized by the user.

If the ClueFrame is in embedded mode 912 then the ClueFrame is constructed within an IFRAME embedded within the rendered DOM of the referrer page (FIG. 2, 235), which is then repositioned 914 relative to the LSC (FIG. 1, 108), according to the offsets given in user preferences (FIG. 3, 362, 363). The corner of the ClueFrame usually presented closest to the LSC would be the top left, but this may have to change if this would result in the ClueFrame appearing off the side of the viewable area of browser window. Ideally the changes result in another corner being presented closest to the LSC, but in some circumstances it may be an edge, or the ClueFrame may even need to be resized to fit within the viewport.

Similar repositioning processes take place if the ClueFrame is to appear within a dependent/modal browser window opened within the browser environment using javascript 919 to remove as much extraneous chrome as possible.

E.g. (for Mozilla Firefox 1.5, in javascript) where x, y, width&height are variables.

floatingWin=window.open(“, ‘ClueFrameWindow’, ‘top=’+y +‘, left=’+x +‘,dependent=yes,location=no, menubar=no,resizable=yes, scrollbars=no,status=no,titlebar =no,height=’+height+‘, width=’+width +‘, innerHeight=’+height +‘, innerWidth=’+width);

If x, y, width&height are not already appropriately set, then a repositioning process 920 similar to 914 above takes place, but relative to the screen edges rather than the browser edges.

Rendering of the inside of the ClueFrame depends on 922 whether Basic or Advanced mode is activated. If advanced then first find all matching ClueScriptTypes (FIG. 3, 373) that are not LinkClueOnly (FIG. 3, 384) from the initialized ClueScripts (FIG. 2, 205) that match the criteria in the user environment, including the current URL info (FIG. 2, 223) and the user preferences (FIG. 2, 204).

These ClueScriptTypes will have been ranked, by the user or otherwise, and should be presented in that order, left to right within separate tabs inside the ClueContentPane. The icon for each tab (FIG. 1, 120) in this embodiment is the same as the LinkClue (FIG. 3, 385, 386). An alternative embodiment (not shown) might present each ClueScript within a separate, possibly collapsible, pane in a scrolling window.

The highest ranked Clue, which in the basic mode is the only clue shown, is now rendered 930 into display form if it has not already been 928, and displayed within the ClueContentPane 932.

Later on the ClueFrame may be closed, either by the user activating a button within the ClueFrame, or moving their mouse outside the Clueframe, or, advantageously, the ClueFrame margin (defined as a constant number of pixels, or using the X, Y offsets set in user preferences (FIG. 3, 362, 363), for, advantageously, a set period of time defined in user preferences (FIG. 3, 361).

In the advanced mode, other tabs are available for the user to select 950 either by hovering their mouse over them for a set period of time (not shown, or use (FIG. 3, 352), or by clicking, according to a user preference (not shown).

If any Cluescripts are set to “ExecutelmmediatelyinClueFrame (FIG. 3, 399), then execute those in the background.

After the user selects a cluescript, it is retrieved from the ClueCache 952 or rendered first 954 and if the same tab is still open 955 then placed 956 within the Clue Content Pane (FIG. 1).

In embodiments not using a tabbed panel, but using the same multiple script mechanism, a similar process would take place when the user opened an outline node, or expanded a hidden div inside a document, for instance.

FIG. 10 illustrates OnPageLoad LinkClues.

FIG. 10 depicts a desktop server flowchart creating LinkClues on page load rather than on mouse over.

On page load 1007 cluescripts that fit the current context are identified 1008 and contents of DOM and list of cluescripts aggregated 1010. All links in the page are then identified 1006 and relevant cluescripts asked for 1009. Optionally, external data for the page is now pre-fetched 1011. If there is not a matching clue 1017 then a clue database 1016 is accessed and URLs and metadata information is bundled 1015. If a matching clue exists 1017 then the clue is 1025 sent to the client. For each clue 1014 the link is located 1018 and LinkClue inserted 1026.

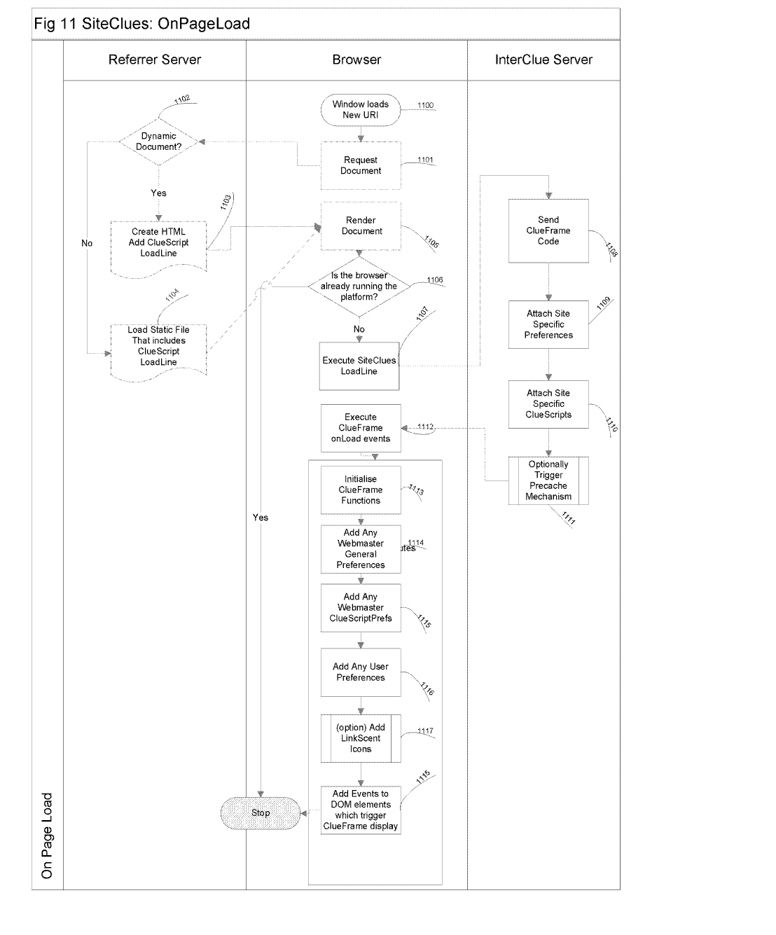

FIG. 11 shows the events which occur in the Web Browser during the onPageLoad event, in cases where a siteclues loadline has been inserted by a webmaster or a proxy server.

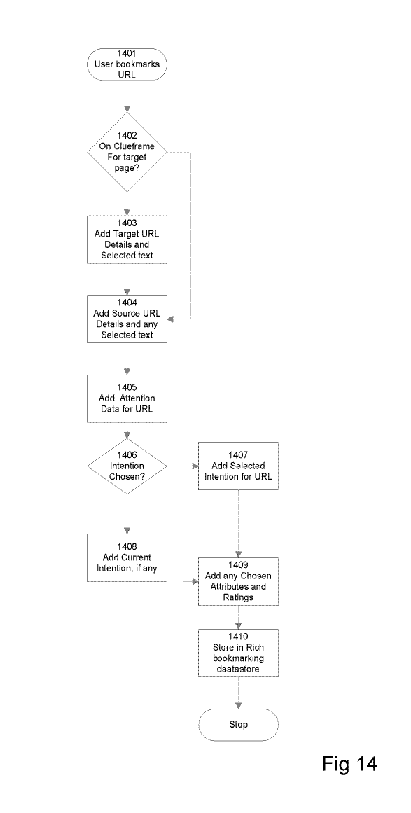

The new URL (1100) is loaded and the document requested from the Referrer Server (1101), which may return a dynamic (1103) or static (1104) document, either way containing an appropriate LoadLine (FIG. 13, 4511 ) which is loaded as the browser creates the DOM (1105).

This is a sample LoadLine for SiteClues:

<script type=“text/javascript”
src=“http://interclue.com/SiteClues.js?SiteID=253423”></script>

Upon rendering this line, the browser (1107) requests SiteClues.js from the Script Server (FIG. 13, 1160) which returns javascript code (1108b) for execution inside the Referrer DOM.

Siteclues.js may optionally check (1106) for the existing presence of platform code (e.g., within the browser) and choose not to continue.

It may optionally (1109) signal the MetaContent Marshal (FIG. 13, 1300) to preemptively create metacontent for documents linked from the referrer URL.

When the page has finished loading, the onPageLoad events attached by the code in SiteClues.js execute and add the necessary elements to the DOM (110b).

Any default preferences and functions (1111) are added to the DOM for later reference.

Any extra preferences (1112) given in subsequent lines within the Referrer Document (FIG. 13, 3040) are added to the DOM.

The default list of Metacontent item types to be used (1113) may be overwritten by the webmaster.

Any user preferences (1114) are added, if they are found within the cookie for the referrer domain.

Icons (LinkClues) (1115) may be added to the DOM elements which the ClueFrame will appear for. Typically, these DOM elements are hyperlinks with an associated URL, Alternatively, they may take the form of an identifier automatically associated with a URL when it appears in a certain context according to the rules of the ClueScript.

Trigger events (1116) are added to the DOM elements to trigger display of the ClueFrame. If the preference is for attaching to the Links, it is attached to them, otherwise, attached to the LinkClue Icons.

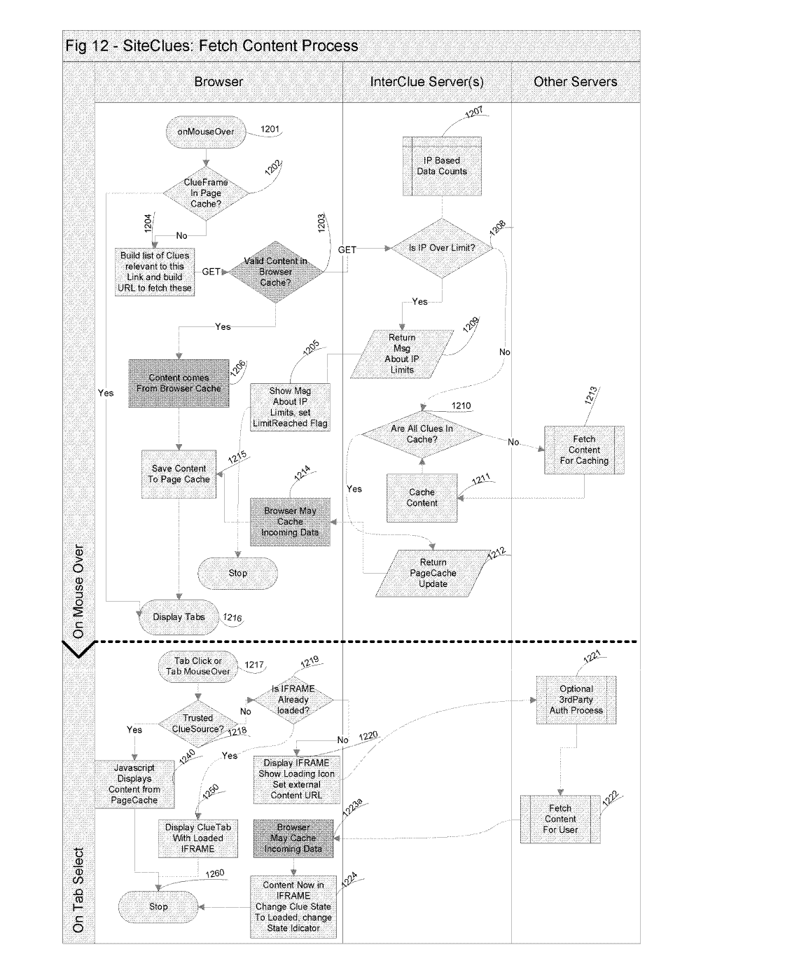

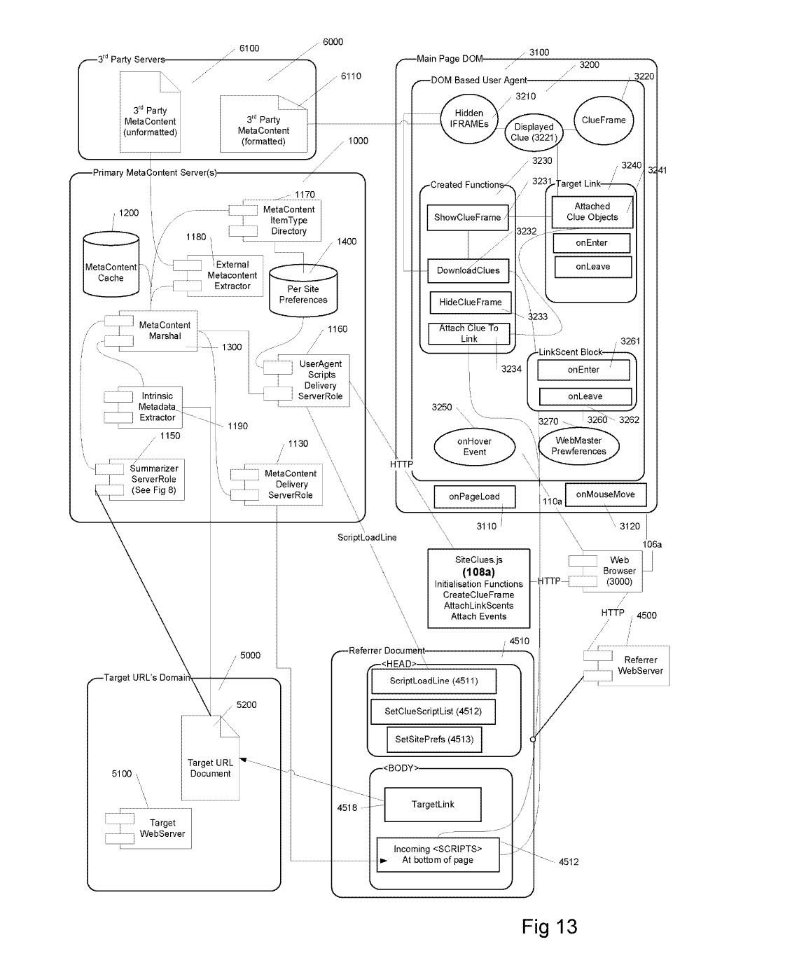

FIG. 12 shows the events which occur as the user interacts with the created DOM.

When the user's mouse cursor pauses for the set hover time on a link or LinkClue to which a Trigger event has been attached in (FIG. 11, 1116),

the onLinkSelect (1200) event is triggered.

The script checks the DOM to see if clues have already been fetched for this link (1201), and if so simply displays the ClueFrame with the available clues.

Otherwise, a default “loading” state is shown (1202), and a URL is constructed to fetch the available metacontent for the target link from the metacontent server (1203), and this URL is inserted at the bottom of the page inside a <SCRIPT> tag (FIG. 13, 4512). If this URL is available in the browser cache (1204) it is sourced from there (1205) otherwise it is called via HTTP GET from the Metacontent Server. (NB: xmlHTTPRequest will not work for the communication process unless the metacontent sever is on the same domain or there are some form of non-standard cross-domain-scription permissions applying)

A sample <SCRIPT> tag used to load metacontent is:

<SCRIPT

src=“‘{server}SiteClues.php?l={linkNum}&s={scriptId}&d={url}&src={currentUrl}&list=’+{ListO
fClueScriptsForPage}”

Where the ListOfClueScriptNames for the page has default values but may be altered by customization stored on the server (1400) or in the web page (4512) and set on pageload (FIG. 6, 113)

Otherwise, on receipt of the URL request, the metacontent delivery server (FIG. 3, 1130) enters a loop (1206-1211) where it checks for each of the requested clues in the Metacontent Cache, and if not available follows the steps in the named MetaContent Itemtype (found in the MetaContent Itemtype Directory (FIG. 3, 1170) to fetch and/or create metacontent for this particular link (1209) and save it into the cache.

In an advanced embodiment (not shown) metacontent may be loaded from multiple servers. And of course images, IFRAME contents, and other embedded objects may be sourced from any appropriate server.

Once all the clues have been fetched it returns the information to the client script (1212). In the preferred embodiment the data is returned as a javascript document that may be cached (1213) containing javascript code fragments which execute on arrival (1214) due to being loaded in an inserted SCRIPT tag (FIG. 13, 4512). On execution they add Clues into the DOM—in the preferred embodiment, calling a function (FIG. 13, 3234) that attaches them directly to the link element (FIG. 13, 3241).

Finally, if the ClueFrame is still open on the relevant link (1215) the tabs are refreshed to display the incoming information (1216).

When a user selects a tab (by clicking on it, or mouseovering, depending on the current preference settings), the onTabSelect event (1217) launches. In embodiments not using a tabbed panel, onTabSelect would be replaced by onitemSelect, which might open an outline node, or expand a hidden div inside a document, for instance.

If the Clue's domain is trusted (1218), then content is displayed from the DOM Cache (240), otherwise the appropriate content is loaded from the appropriate metacontent source (FIG. 6110) into a hidden IFRAME (FIG. 13, 3210). This URL may already be in the browser's cache in which case it will appear immediately (1250). Otherwise it is requested from the 3^{rd} party server (1222) which may first authenticate the user by way of login in the IFRAME (1221), or by some other authentication method.

When the IFRAME has been loaded, and optionally cached by the browser (1223) it will appear to the user only if that ClueTab is currently visible (1224).

(FIG. 13) SiteClues Structure with scripts hosted on another server.

FIG. 13 shows a standard modern web browser (3000), displaying a Referrer Document (4510) which contains at least one hyperlink (4518) to a target URL (5200). The Referrer URL also contains a LoadLine (4511) which references a URL from the Script Delivery Server (1160).

In Step 106athe web-browser constructs the Document Object Model (3100) described by the Referrer Document (4510), and in doing so it executes the LoadLine (4511) that fetches scripts (1108a) from the Script Delivery Server (1160), which creates in step 110a the DOM based user-agent (3200) which is a central part of the present invention. Preference settings and Metacontent Item Types (ClueScripts) for the User-Agent may either be customized by the referring document (4512, 4513), or the custom values stored on the Server (1400) and updated by the site owner from time to time.

When the user selects a link, metacontent for that link is downloaded from the metacontent delivery server (1130), which either finds it in the server's cache (1200) or causes the Metacontent Marshal (1300) to look up the definition from the MetaContentitemType/ClueScript directory (1170) and cause it to be downloaded and created either from summarizing the target page (1150), extracting or creating metadata based on the target page (1190), or extracting metacontent from external servers (1180), after which it is stored in the Cache (1200).

The User triggers the bookmark button on Clueframe or browser controls (1401). If the clueframe button was used and it was open for a target link (1402) then add target details and selected text (1403), and in any case do the same for the the referrer document (1404). Then add any relevant data from that attion datastore for this url (1405). If the user selects a relevant intent for this bookmark, add that also (1407) if not then add the user's current stated intention, if any (1408). Add any attributes or ratings chosen by the user within the clueframe (1409) and then store it all in the rich bookmarking datastore (1410)

The disclosure herein is to be considered as an exemplification of the principles of the invention and is not intended to limit the broad aspect of the invention to the embodiments illustrated. Thus, the scope of the invention is determined by the appended claims and their legal equivalents rather than by the examples given.

What is claimed is:

1. A method for augmenting a Document Object to display information from an external source relevant to the URLs linked from the Document, comprising: inserting a script into the document that when rendered by a compatible web browser causes the link objects within the Document Object to be augmented with extra information relevant to the linked URL, said information obtained from a different domain than the one on which the Document resides.

2. The method of claim 1 where the Document has instead a short script embedded into the Document that when rendered by a capable web browser causes a larger script to be downloaded and executed within the Document Object that subsequently causes the link augmentation;
creates a client script within the DOM that fetches content from an offsite server to augment the first document in response to user activity;
alters the document object model of the page to embed an icon next to a link; and,
fetches content to the user information relevant to the links.

3. A method for augmenting hyperlinks within a hypertext document to display information (metacontent) relating to the target document of the hyperlink without requiring the reader to leave the context of the currently viewed document, by altering the Document Object Model (DOM) of the viewed document comprising displaying metacontent items in the context of content items within a source document by using scripts wherein the metacontent relates to hyperlinked content within a source document.

4. A method for including said scripts within a hypertext document comprising:
(a) inserting a LoadLine of a specific format into the document markup that executes immediately, and may set a time for the rest of the initialization to occur if appropriate;
(b) indicating the selection of individual content items by the user in events created within the Document Object Model, including hovering a mouse pointer over a link, or a setTimeOut timer attached to the onMouseMove events that will activate functions when the mouse has stopped moving for the TimeOut period, at which point it can be determined if the mouse is sitting on top an link, an inserted icon, or another activation point.

5. The method of claim 4 further comprising the step of displaying metacontent items, triggered by said events wherein a metacontent server makes metacontent items available for display in a suitable format for display using metacontent display scripts.

6. The method of claim 4 further comprising the step of augmenting hyperlinks to indicate the availability of specific metacontent items or metacontent item types, for instance by way of inserting icons adjacent to the hyperlinks.

7. The method of claim 4 further comprising the step of associating unlinked content items with URLs for the purpose of providing appropriate metacontent for those content items using the same methods used to augment hyperlinks.

8. The method of claim 4 further comprising the step of controlling the appearance and behavior of indicators, for instance whether the indicators are visible on pageload or when a content item has the mouse pointer hovered over it for a set period of time.

9. The method of claim 4 further comprising the step of controlling the appearance and behavior of the metacontent container.

10. The method of claim 4 further comprising the step of controlling the appearance and behavior of individual metacontent item types.

11. The method of claim 4 further comprising the step of controlling which metacontent item types should be displayed if they are available.

12. The method of claim 4 further comprising the step of adding script lines to web pages to make the customizations at runtime.

13. The method of claim 4 further comprising the step of adding a file on a domain linked from the pages or a default filename in a default location within the domain.

14. The method of claim 4 further comprising the step of making customizations on a central server to require a central configuration panel and either Parameters on the Loadline(s) identifying the page or set of pages, or Parameters on the Loadline(s) identifying the owner of the page, or identifying the pages from a URL, or an ID stored within an appropriate file as above.

15. The method of claim 4 further comprising the step of adding setting aside an IFRAME to show metacontent items relevant to a first web page, wherein said IFRAME may be invisible until triggered by the user.

16. The method of claim 5 wherein a metacontent Item type is selected from a group consisting of a summary of the linked file (and for HTML, embedded, linked or associated files), an image created that reflects the linked file (and for HTML, embedded, linked or associated files), Metadata extracted from the linked file (and for HTML, embedded, linked or associated files), Metadata created by an analysis of the linked file (and for HTML, embedded, linked or associated files), Metacontent relevant to the linked file (and for HTML, embedded, linked or associated files) extracted and optionally transformed from external sources.
